(19) United States
(12) Patent Application Publication
(10) Pub. No.: US 2017/0092150 A1
(43) Pub. Date: Mar. 30, 2017

(54) SYSTEM AND METHOD FOR INTELLIGENTLY INTERACTING WITH USERS BY IDENTIFYING THEIR GENDER AND AGE DETAILS

(71) Applicants: Sultan Hamadi Aljahdali, Jeddah (SA); Fayas Asharindavida, Jeddah (SA)

(72) Inventors: Sultan Hamadi Aljahdali, Jeddah (SA); Fayas Asharindavida, Jeddah (SA)

(21) Appl. No.: 14/872,084

(22) Filed: Sep. 30, 2015

(51) Int. Cl. G09B 19/00; G06K 9/00

(52) U.S. Cl. CPC G09B 19/0053; G06K 9/00255; G06K 9/00248; G06K 9/00281; G06K 9/00288; G06K 2009/00322

(57) ABSTRACT

The embodiments herein provide a system and method for intelligently delivering the appropriate content to the right people. It is carried out by automatically identifying the gender and age details from the user images. The system includes a display device and an image processing unit. The image processing unit detects the face area from the captured image and extracts the various face features for the analysis. The image processing unit classifies the user into male or female and estimates the age group based on the wrinkles and other age marks detected. Based on the information of gender and age the system will interact with the user and deliver appropriate information in an efficient way.

### FIELD OF THE INVENTION

The present invention relates to a field of image processing and user interaction. More particularly, the present invention is related to a system and method for efficiently interacting with the users by delivering appropriate contents based on their gender and age details.

### BACKGROUND AND PRIOR ART

Computers are machines which will respond according to the instruction given to them. All user interactive systems are working by taking in consideration that a user is trying to interact with it. So based on the programs installed, it will respond to the user despite of gender or age.

There are many ways for getting a help for a user. If he wants money he can go to any bank, if he needs any route information or tickets for travelling he can go to the ticket counter.

Today world has become digital and for every service we have digital systems. Either it is ticket vending machine or an ATM machine or even a help desk. All these machines are responding to the user in a uniform fashion by considering it as a normal user. It would be better if the machine shows the instructions in a better way for user's convenience. The user may be an old person who wants the details to be shown in a bigger way so as to read and understand the information easily.

Nowadays everybody is using ATM machines for money transactions. In this busy life nobody is patient enough to stay in a queue for the tickets or getting any help. They use ticket vending machines and help desk or kiosks. Even for the airline passengers now there are e-gates for the self service check in and boarding pass services. In all these cases the instructions for the user interaction are displayed despite of any gender or age.

Most of the advertisements are done digitally using big display devices. You can see them in airports, railway stations, shopping malls, etc. The use of an advertisement is to inform people about a particular product. There are certain products which are specifically indented to a specific gender. Or there are many products which are specific for some age groups. But the current digital advertisements are showing all their product details to all sorts of people.

Imagine a digital advertisement system which is showing the advertisements specific for a gender or a specific age group. The effect of such an advertising system will become highly successful and popular among the customers. Similarly, if the devices are interacting with the users in an efficient way by considering the users age and gender will be very useful and successful.

Currently there are no such systems which interacts the user automatically with their age and gender. It will be very beneficial if the system interacts with the user according to their gender and age. Thus there exists a requirement for a system and method for interacting users based on the specific gender and age group.

The above mentioned shortcomings, limitations and disadvantages are addressed herein and which will be understood by reading and studying the following specifications.

### OBJECTS OF THE EMBODIMENTS

The primary object of the embodiments herein is to deliver exact information efficiently to the user by considering their gender and age.

Another object of the embodiment herein is to provide an efficient system for giving related information to the user and a method to analyze the gender and age of the user.

Another object of the embodiment herein is to provide a user interactive system and a method for identifying the age and gender of the user with an image capturing device in real time.

Another object of the embodiment herein is to provide an intelligent interactive system which will give appropriate information to the user by understanding their gender and estimating their age.

Yet another object of the embodiment herein is to provide an automatic interactive system and a method for delivering specific information to the correct gender and age group.

Yet another object of the embodiment herein is the interactive system to deliver useful and required information based on the users age and gender details.

Yet another object of the embodiment herein is to provide an efficient interactive system and a method to effectively find out the gender of the user and deliver suitable information to them.

Yet another object of the embodiment herein is to provide an intelligent interactive system and a method to effectively estimate the age of the user and deliver suitable information to them.

Yet another object of the embodiment herein is to provide an intelligent interactive system and a method for automatically capturing the user image for finding his gender and age.

Yet another object of the embodiment herein is to provide an intelligent interactive system and a method for automatically analyzing the texture of the skin for smoothness and presence of hair from the user face image.

Yet another object of the embodiment herein is to provide an intelligent interactive system and a method for analyzing the face image for wrinkles, age spots and dark circles.

Yet another object of the embodiment herein is to provide an intelligent interactive system and a method for analyzing the face image for estimating the age.

Yet another object of the embodiment herein is to provide an intelligent interactive system and a method which requires very less time for analyzing the face image.

Yet another object of the embodiment herein is to provide an intelligent interactive system based on the user details and a method for finding the gender and age without user intervention.

The objects and the advantages of the embodiments herein will become readily apparent from the following detailed description taken in conjunction with the accompanying drawings.

### SUMMARY OF THE INVENTION

The embodiments herein provide a system for interacting users intelligently with estimating their gender and age details by analyzing the facial features of the face images of the user. The system includes an image capturing device and a device which contains display device with an image processing unit in it. The device could be any device which is interacting with the users such as ATM machine, help desk, ticket/boarding pass vending machine, etc. The image capturing device captures the image of a user and gives to the image processing unit inside the device. The image processing unit contains face detection and face region analysis module as well as an age estimation and gender estimation module.

The display device herein is the display part of the interacting machine and the image capturing device is any two dimensional camera or video recorder. The image processing unit detects the face area from the image captured and extracts the facial features from it. It will analyze the face regions for the texture of skin, wrinkles, age marks and shape of the facial parts. Based on the analysis, gender and age of the user is estimated and further appropriate content is delivered to the user based on the gender and age estimated.

The embodiments herein provides a method for intelligently responding to a user according to the gender and age group. The method detects the face area from the image and segments the facial regions from the image. The method also includes extracting the facial features for the estimation of the gender and the age details. For this purpose, the face regions are analyzed and detect the wrinkles, texture, age marks, shape and dark marks in the face image. The method further classifies the features into male or gender based on the details. The method also includes the estimation of the age based on the facial features extracted from the face image. The method further delivers the information intelligently to the user with the age and gender already estimated.

According to an embodiment herein, the user will not be shown about the processes which are been carried out for the gender and age estimation.

According to an embodiment herein, the display device could be any user interactive device with an image capturing and processing unit. It is not limited to any touch screen device, PDA, and a mobile device.

According to an embodiment herein, the image processing unit analyses the image and detects the face in it and extract face regions for the further processing. Further processing includes the detection of the various age marks such as wrinkles, blemishes, dark circles and texture of the skin.

According to an embodiment herein, the image processing unit removes the false detections of age marks and wrinkles and evaluates the system for the correct values for the smoothness and texture of the skin.

According to an embodiment herein, the image processing unit analyzes the shape of the facial regions such as eyes and chin which are useful for the gender estimation.

According to an embodiment herein, the image processing unit estimates the density and count of the wrinkles and age marks which are used for the age estimation.

According to an embodiment herein, the image processing unit estimates the gender of the face based on various features like the texture of the skin, shape of the face regions, presence of hair and smoothness of the skin.

According to an embodiment herein, the image processing unit estimates the age of the user based on the amount of wrinkles and age marks detected from the facial regions.

According to an embodiment herein, the image processing unit displays correct information to the user based on the gender and age estimated from the image captured.

According to an embodiment herein, the system responds to the user in the appropriate and efficient way according to the age and gender estimated.

These and other aspects of the embodiments herein will be better understood when considered in conjunction with the following description, claims and drawings.

### BRIEF DESCRIPTION OF THE DRAWINGS

Above aspects of the inventions are described in detail with reference to the attached drawings, where:

FIG. 1 illustrates the block diagram of the intelligent interactive system according to an embodiment herein.

FIG. 2 illustrates a flow chart explaining a method for intelligently interacting the user with identifying the gender and age of the user according to an embodiment herein.

FIG. 3 illustrates a flow chart explaining the overall flow of the method which interacts with appropriate contents to the user, according to an embodiment herein.

FIG. 4 illustrates a flow chart explaining a method for detecting the face from the image captured and extract regions from face, according to an embodiment herein.

FIG. 5 illustrates a flow chart explaining a method for classifying user into male or female gender, according to an embodiment herein.

FIG. 5A illustrates a flow chart explaining a method for calculating the density of the texture of the skin, according to an embodiment herein.

FIG. 5B illustrates a flow chart explaining a method for estimating the density of the hair, according to an embodiment herein.

FIG. 5C illustrates a flow chart explaining a method for analyzing the face shape and shape of the eyes, according to an embodiment herein.

FIG. 6 illustrates a flow chart explaining a method for classifying the user into age groups, according to an embodiment herein.

FIG. 6A illustrates a flow chart explaining a method for detecting the wrinkles present in the face, according to an embodiment herein.

FIG. 6B illustrates a flow chart explaining a method for detecting age marks in the face, according to an embodiment herein.

FIG. 6C illustrates a flow chart explaining a method for estimating the color density of the dark circles around the eyes, according to an embodiment herein.

The specific features of the embodiments herein are shown in some drawings and not in others. It is because some features may be combined with any or all of the other features in accordance with the embodiment herein.

### DETAILED DESCRIPTION OF THE INVENTION

In the following detailed description, a reference is made to the accompanying drawings that form a part hereof, and in which the specific embodiments that might be used is shown by way of illustration.

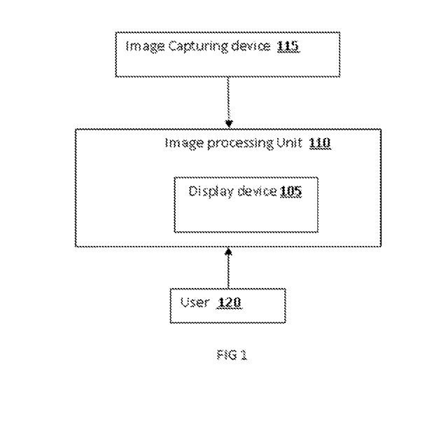

FIG. 1 illustrates the block diagram of the intelligent interactive system according to an embodiment herein. With reference to FIG. 1, the proposed interactive delivery system consists of a display device 105, an image processing unit 110 and an image capturing device 115. The image capturing device 115 is two dimensional camera or a video recorder. It is mounted onto the display device 105 and is used to capture the images of the user 120 approaching towards the interactive system. Display device 105 is not limited to a normal display device but it is a system which does any specific function such as money or ticket vending, helping to find the way etc. The user 120 approaches the display device 105 and the image is captured by the image capturing device 115 and is given to the image processing unit 110. This image processing unit has two components, one is the gender estimation part and other is the age estimation part. In the image processing unit 110, the image is processed to find out the gender and estimates the age of the user. As per this result the user 120 gets information intelligently based on the age and gender.

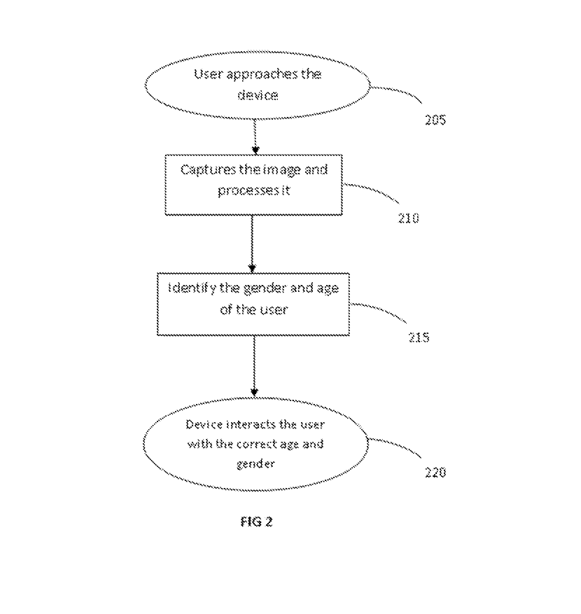

FIG. 2 illustrates a flow chart explaining a method for intelligently interacting the user by identifying the gender and age of the user according to an embodiment herein. The user approaches the device where he has to get any help in terms of any service or information (step 205). The device automatically captures the image of the user and processes it (step 210). Image capturing is done by the capturing device mounted on the device. From the image face is detected and the further processing is concentrated on this part of the image only. Facial regions are extracted from the face part for finding out the features. From these regions wrinkles, age marks and dark circles are detected and density is calculated. Shape of the eyes and chin is analyzed and texture of the skin is also estimated.

Next stage is the identification of gender and estimation of the user age (step 215). Based on the features calculated in the previous step 210, its classification is done and the age of the user is also estimated. In the next step the device starts interacting with user or deliver information based on the age and gender estimated. By this way user is getting the correct and appropriate information displayed in the suitable way according to their gender and age (step 220).

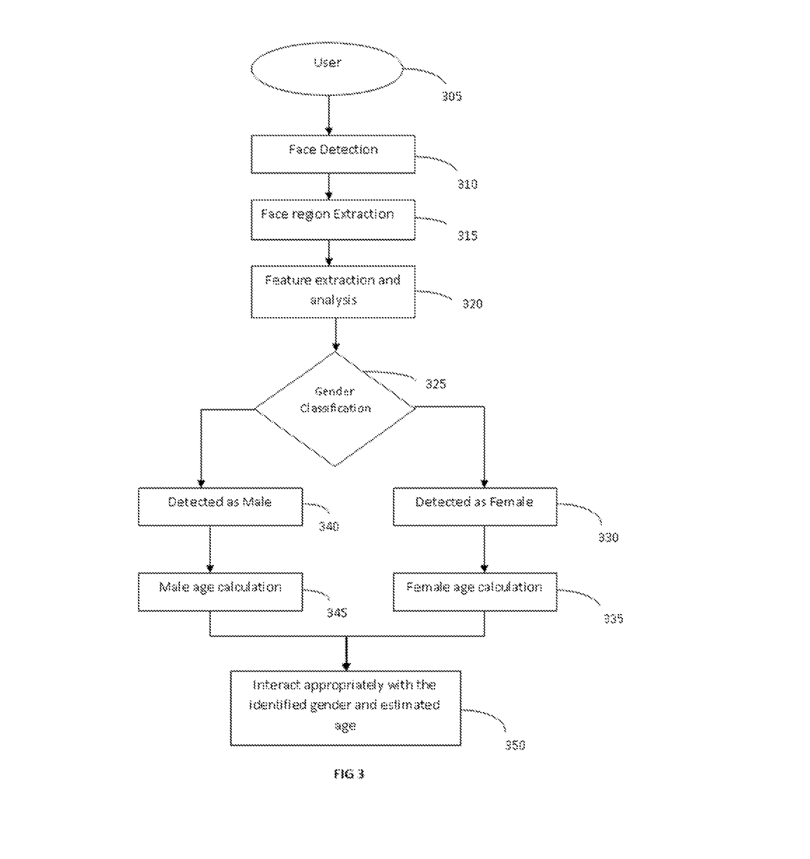

FIG. 3 illustrates a flow chart explaining the overall flow of the method which interacts with appropriate contents to the user, according to an embodiment herein. Image of the user is taken by the image capturing device (step 315). Next step in the flow is to detect the face area from the image (step 310). It is done by applying the hair classifier which works with the training given by thousands of face images. Next step here is to extract the facial regions from the face image (step 315). Facial regions extracted are forehead, eyebrows, eyes, chin area, lips, and the boundary of the face. This is achieved by applying Active Appearance Model (AAM) to the image. Active appearance model works with the fitting of active contours to the face regions based on the training given. In the following step features are extracted and analyzed (step 320). Features under consideration are wrinkles, age marks, blemishes, dark circles, shape of the eyes, shape of the chin, density of the hair and the texture of the skin. Next step is to classify the gender based on the features analyzed in the previous step (step 325). Features for the gender estimation are shape of the eyes, shape of the chin, texture of the skin and the presence of the hair in the moustache and beard region in the face.

Based on the features given for the classification in step 325 it is either classified as male or female. If the features like shape of the eyes, shape of chin, texture of the skin and detection of hair are giving results towards female then the user is classified as female. Similarly, if the shape of the eyes, skin texture and detection of hair is giving positive results for male gender, it is classified into male (step 340). If the gender identified is female (step 330), age calculation for the female part is done (step 335). Similarly if the gender identified is male, age calculation for male is carried out (step 345). For the age calculation features like wrinkles, age marks, texture of the skin and dark area around the eyes are considered. Based on the gender and age calculated the user is provided with the correct information and deliver the services very efficiently. So interact appropriately with the identified gender and estimated age is complete (step 350).

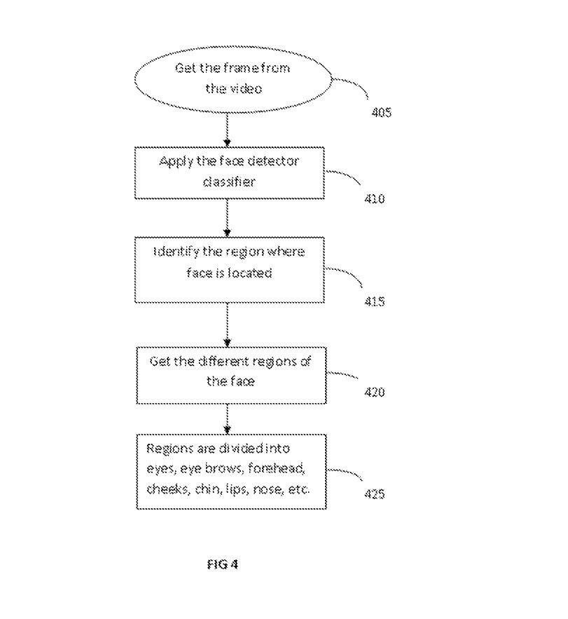

FIG. 4 illustrates a flow chart explaining a method for detecting the face from the image captured and extract regions from face, according to an embodiment herein. Image is taken by the capturing device. The camera is working continuously and when motion of an object is detected it captures the frame and it is given to the image processing module (step 405). From the image, applying the face detector classifier (step 410), face region is extracted using the modified hair classifier which will find out the face region efficiently and the location is given for further processing (step 415). Next step is to find out the various facial regions from the face image (step 420). For this purpose Active Appearance Model (AAM) is used. This is based on the training given on thousands of images which are marked properly to get exact results from the input image. In step 425, the regions are divided into eyes, eye brows, forehead, chin, lips, nose and the outer border of the face which gives the shape of the face. From regions are derived from these defined regions by mathematical calculations. They are the moustache area, area around the eyes and the beard area which are found out with the help areas defined by lips, nose and eyes.

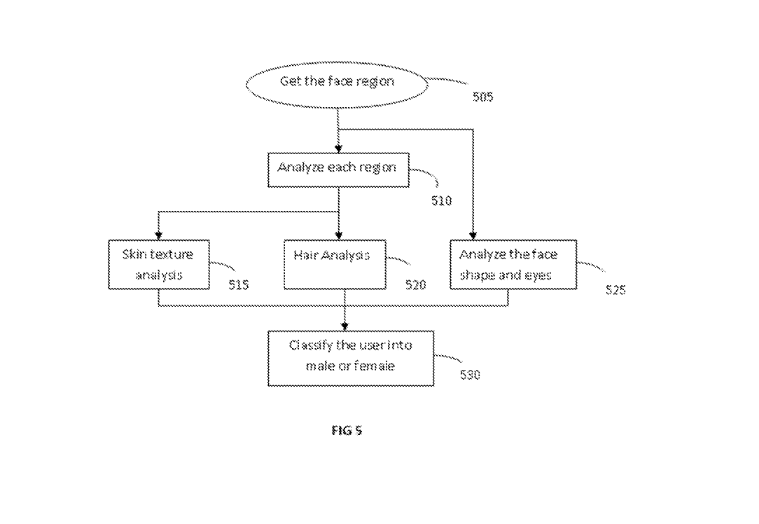

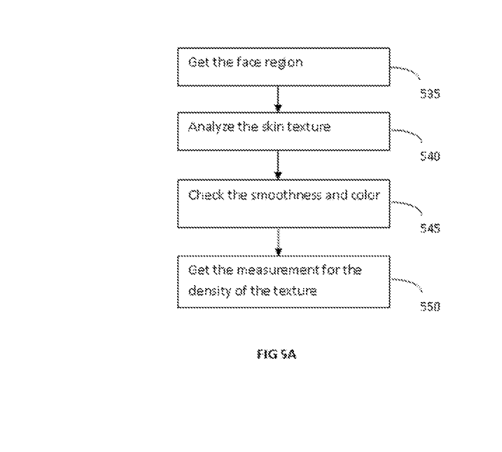

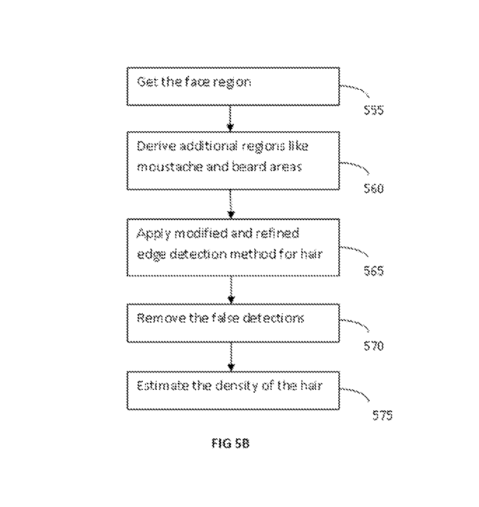

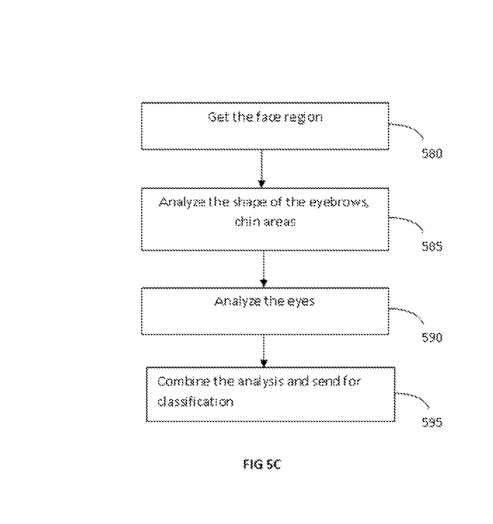

FIG. 5 illustrates a flow chart explaining a method for classifying user into male or female gender, according to an embodiment herein. After getting the face region (step 505), the face area detected is used for the analysis the facial regions (step 510). The facial regions are extracted using the Active Appearance Model. Thousands of images are trained from different gender and ethnic for the efficient extraction of the facial parts. For each of the facial regions, feature extraction and analysis is done. There are three major components in this step. First one is the skin texture analysis module (step 515). In this, the texture of the skin is analyzed for smoothness and color. This is explained in detail as illustrated in FIG. 5A. The second component is for the analysis of hair (step 520) on the face region. It is easy to judge if a considerable amount of hair is detected on the moustache or beard area. Hair detection method is further explained as illustrated in FIG. 5B. The third component is for analyzing the shape of the face and eyes (step 525). This method is explained in detail as illustrated in FIG. 5C. Based on these three components, different features are extracted and those estimations are given for the classification (step 530). We will use the heuristics and rules for classifying the features to male or female gender. It is done with the help of support vector machine with modified kernel adjusted to our heuristics and rules.

FIG. 5A illustrates a flow chart explaining a method for calculating the density of the texture of the skin, according to an embodiment herein. The face regions are extracted from the input image captured by the capturing device (step 535). For each of the face regions skin texture is analyzed (step 540). The color and the smoothness of the skin is analyzed at this point (step 545). Color of the skin is analyzed by correcting the lighting so that we get the correct details. Smoothness is analyzed by the appearance model used for the extraction of face regions. Amount of the smoothness and color is estimated based on the density of its content in the particular area (step 550). These density measures are given for the classification method as illustrated in step 530.

FIG. 5B illustrates a flow chart explaining a method for estimating the density of the amount of hair, according to an embodiment herein. Facial parts are extracted from the face region detected (step 555) using the active appearance model and contours for separating it. As mentioned earlier the regions extracted are forehead, eyes, nose, eye brows, lips and the boundary of the face. For the detection of hair additional regions are derived from these areas (step 560). Moustache area is derived by considering the nose region and the lips area. Similarly the beard area is derived from the face boundary and the end points of the lips. Modified and refined edge detection method is applied to these areas for the detection of possible hair (step 565). Before applying this filter specialized smoothing is done on these regions for avoiding the false detections. Possible false detection of hairs are avoided by applying some heuristics such as applying thresholds and discontinued or uneven hairs (step 570). Density of the detected hair content is analyzed (step 575) and an estimate of the same is given for classification.

FIG. 5C illustrates a flow chart explaining a method for analyzing the face shape and shape of the eyes, according to an embodiment herein. Facial parts are extracted from the detected face regions (step 580). Shape of the particular facial parts is analyzed as it is useful for determining the gender. For this purpose we analyze the shape of the eye brows and the shape of the chin areas (step 585). Shape of the eyes is also very useful for determining the gender. So the region of eyes is also analyzed for this purpose (step 590). The characteristics of the eyebrows chin and the eyes are combined (step 595) and the assessment is sent for classification as illustrated in step 530. In order to make the results of this analysis correct we have trained the system with thousands of facial images with specific to these regions for both genders.

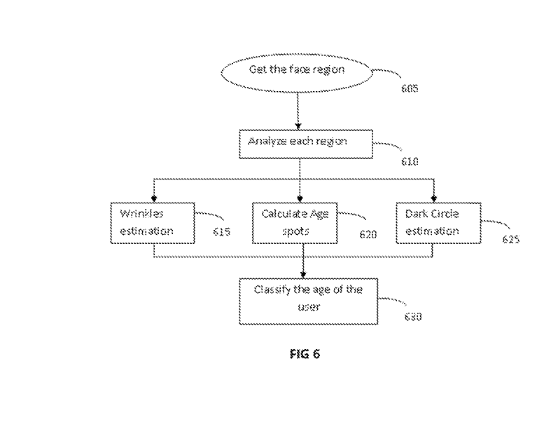

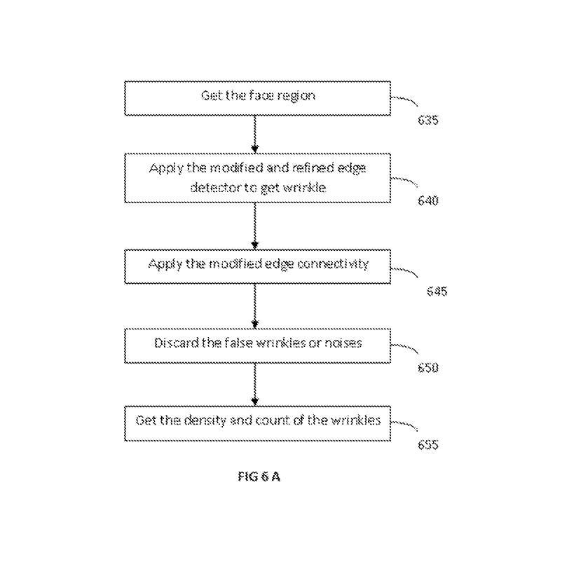

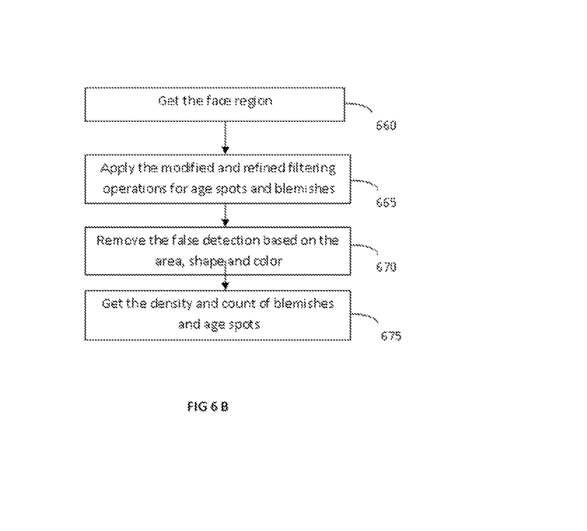

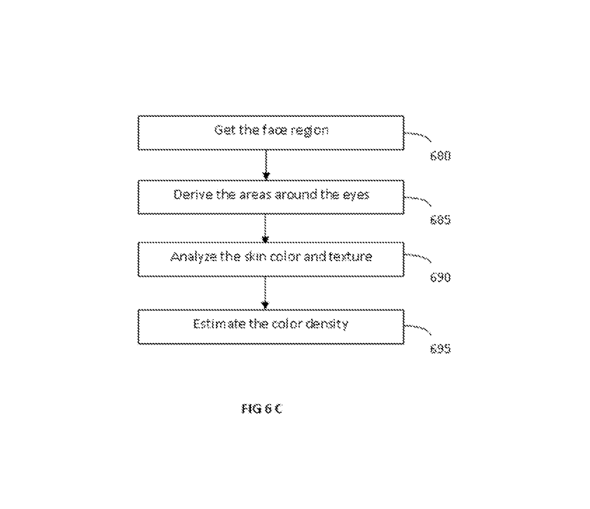

FIG. 6 illustrates a flow chart explaining a method for classifying the user into age groups, according to an embodiment herein. Facial parts are extracted from the face region detected (step 605) using the active appearance model and contours for separating it. These regions are analyzed for detecting the various age marks which may occur on the face (step 610). Based on the various age marks there are three components to this method for their detection purpose. First one is the wrinkle estimation (step 615) which is a common and strong evidence for age estimation. The detection method is explained in detail as illustrated in FIG. 6A. Second component is for calculating the age spots (step 620). Age spots include blemishes and age marks in the face. The detection and estimation method is explained in detail as illustrated in FIG. 6B. Third component is for estimating the dark area around the eyes (step 625) which is often called as dark circles. Estimation of this dark area is explained in detail as illustrated in FIG. 6C. After getting the estimation of wrinkles, age spots and dark circle it is given for the classification of the user age (step 630). It is done with the help of support vector machine with modified kernel adjusted to our heuristics and rules.

FIG. 6A illustrates a flow chart explaining a method for detecting the wrinkles present in the face, according to an embodiment herein. Facial parts are extracted from the face region detected (step 635) using the active appearance model and contours for separating it. These regions are analyzed for detecting the wrinkles which occur on the face that can be used for assessing the age. In these regions modified and refined edge detector is applied to get the wrinkles (step 640). Basically wrinkles are edges or valleys on a digital image. So by applying the modified filters we will get some edges which correspond to wrinkles. Apply the modified edge connectivity for connecting the discontinued edges detected (step 645). There could be false wrinkles that are detected as wrinkles; they are discarded by analyzing the details of the wrinkles detected (step 650). There are chances of noises also which might get detected as wrinkles, which are also discarded at this step. Density and count of the wrinkles are estimated (step 655) and send for the classification as illustrated in 630.

FIG. 6B illustrates a flow chart explaining a method for detecting the age marks in the face, according to an embodiment herein. Facial parts are extracted from the face region detected (step 660) using the active appearance model and contours for separating it. These regions are analyzed for detecting the age marks which occur on the face that can be used for assessing the age. In these regions modified and refined filtering operations are applied to detect the age spots and blemishes (step 665). Specialized filters are used for the detection age marks and blemishes. There are chances of false age spots and blemishes due to some errors in the process. These false detections are removed or discarded based on the heuristics of the location of the marks, its shape, size and color (step 670). Density of the age spots and blemishes are calculated based on the pixel intensities in this area. Count of the blemishes are also considered for estimating the age of the user (step 675). This density measure and the count are given to the classification process as illustrated in step 630.

FIG. 6C illustrates a flow chart explaining a method for estimating the color density of the dark circles around the eyes on the face, according to an embodiment herein. Facial parts are extracted from the face region detected (step 680) using the active appearance model and contours for separating it. Areas around the eyes are derived from the defined regions of eyes and nose (step 685). These regions are analyzed for the skin color and texture which occur on the face that can be used for assessing the age (step 690). The dark region is estimated based on the skin details which includes the smoothness and color of the pixels in that area (step 695). This estimate is used for the classification of the age as illustrated in step 630.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. An efficient user interaction system comprising:
a) a digital screen;
b) an image capturing device attached to the digital screen to capture an image of a user;
c) an image processing unit attached to the digital screen for analyzing a face image captured, detecting a gender and estimating an age of the user; and
d) wherein the digital screen delivers correct and appropriate contents to the user based on the gender detected and the age estimated from the image processing unit.

2. The system of claim 1, wherein the digital screen includes a display unit for displaying the contents to the user after detecting the gender and estimating the age of the user.

3. The system of claim 1, wherein the image processing unit includes:
a) face detection module for detecting a face area from an user image;
b) a facial region extraction module for analyzing every part of a face of the user;
c) a gender identification module for identifying the gender based on features extracted;
d) an age estimation module for calculating the age of the user; and
e) an intelligent interactive information delivery module based on the gender and the age of the user.

4. The system of claim 1, wherein the digital screen delivers appropriate information to the user.

5. The system of claim 1, where in the image capturing device is a two dimensional digital camera.

6. The system in claim 1, where in the system automatically identifies the gender and the age of the user without any prior information or physical interaction.

7. A method for intelligently deliver information to a user, the method comprises:
a) capturing an image of the user;
b) transferring the captured image to an image processing unit;
c) detecting a face region from the captured image;
d) analyzing the facial regions and texture of skin of the user;
e) finding a gender of the user from facial characteristics;
f) detecting skin marks occurring due to ageing;
g) estimating an age of the user based on the age marks; and
h) delivering correct information to the user based on the gender and the age.

8. The method of claim 7, wherein transferring of image to the processing unit and finding out the gender and the age is carried out in very less time without even noticed by the user.

9. The method of claim 7, wherein the step of detecting is done by a modified cascaded classifier which is enhanced by giving extra training with thousands of extra images.

10. The method of claim 7, wherein the step of analyzing includes a modified appearance model which is used with an extensive training of face images and analysis of the facial regions done by taking the shape of eyes, eye brows and chin of the user.

11. The method of claim 7, wherein features extracted from the face includes:
a) age marks including wrinkles, blemishes, age spots and any other marks associated with skin of the user;
b) face features including texture of skin, shape of the eyes and eyebrows of the user.

12. The method of claim 7, wherein the gender estimation is done by analyzing texture of user's skin and analyzing the shape of user's facial parts.

13. The method of claim 7, wherein one method for the gender estimation is done by the analysis of user's hair content on the face.

13. The method of claim 7, wherein the age of the user is estimated based on the age marks including wrinkles and other age marks.

14. The method of claim 7, wherein the age marks including wrinkles and age marks are detected based on refined edge detection methods.

15. The method of claim 7, wherein the gender estimation is done by analyzing the shape of some user's facial parts and by finding the density of user's hair.

16. The method of claim 7, wherein the gender and the age estimated are not shared with the user but instead it delivers appropriate content based on them.

17. The method of claim 7, wherein a gender and age group of the user is calculated and information is delivered very efficiently and appropriate to the user.

18. A system and method for intelligently and efficiently interacting with users by appropriate information and help them in understanding or getting a correct service without even saying any word or physical contact with the system.
